(19) United States
(12) Patent Application Publication
(10) Pub. No.: US 2026/0133718 A1
(43) Pub. Date: May 14, 2026

(54) MEMORY SYSTEM

(71) Applicant: Kioxia Corporation, Tokyo (JP)

(72) Inventor: Hiroshi KATOUGI, Isehara Kanagawa (JP)

(21) Appl. No.: 19/315,179

(22) Filed: Aug. 29, 2025

(30) Foreign Application Priority Data
Nov. 13, 2024 (JP) 2024-198079

(51) Int. Cl. G06F 3/06

(52) U.S. Cl. CPC G06F 3/0659; G06F 3/0625; G06F 3/0634; G06F 3/0679

(57) ABSTRACT

An external memory system for an audio device, includes a nonvolatile memory including a plurality of nonvolatile memory chips, and a memory controller configured to communicate with the audio device and store, in the nonvolatile memory, audio data transmitted from the audio device. The memory controller is configured to switch between a normal mode and a high quality mode, upon receipt of audio data in the normal mode, encode the audio data and store the encoded audio data in the nonvolatile memory, and upon receipt of audio data in the high quality mode, assign a flag to the audio data and store the audio data in the nonvolatile memory without encoding the audio data.

### CROSS-REFERENCE TO RELATED APPLICATION

This application is based upon and claims the benefit of priority from Japanese Patent Application No. 2024-198079, filed November 13, 2024, the entire contents of which are incorporated herein by reference.

### FIELD

Embodiments described herein relate generally to a memory system.

### BACKGROUND

A known memory system includes a nonvolatile memory such as a NAND flash memory (hereinafter simply referred to as “NAND memory”), and a memory controller that controls the NAND memory. One example of the memory system is a solid state drive (SSD).

There is a known audio device that reads melodic information stored on a hard disk, a memory card, and the like, and reproduces the read melodic information.

### BRIEF DESCRIPTION OF THE DRAWINGS

FIG. 1 is a block diagram illustrating a configuration of an information processing system including a memory system according to a first embodiment.

FIG. 2 is a block diagram illustrating a configuration of the memory system according to the first embodiment.

FIG. 3 is a flow chart illustrating an overview of writing music data in a memory system according to a comparative example.

FIG. 4 is a flow chart illustrating an overview of reading the music data in the memory system according to the comparative example.

FIG. 5 is a flow chart illustrating an overview of writing music data in the memory system according to the first embodiment.

FIG. 6 is a flow chart illustrating an overview of reading the music data in the memory system according to the first embodiment.

FIG. 7 is a flow chart illustrating a second overview of writing the music data in the memory system according to the first embodiment.

FIG. 8 is a block diagram of a memory system according to a second embodiment, focusing on a host I/F.

FIG. 9 is a block diagram of a memory system according to a third embodiment, focusing on a NAND chip.

### DETAILED DESCRIPTION

Embodiments provide a memory system that enables a connection-destination audio device to reproduce melodic information with higher quality.

In general, according to one embodiment, an external memory system for an audio device, comprises: a nonvolatile memory including a plurality of nonvolatile memory chips; and a memory controller configured to communicate with the audio device and store, in the nonvolatile memory, audio data transmitted from the audio device. The memory controller is configured to: switch between a normal mode and a high quality mode, upon receipt of audio data in the normal mode, encode the audio data and store the encoded audio data in the nonvolatile memory, and upon receipt of audio data in the high quality mode, assign a flag to the audio data and store the audio data in the nonvolatile memory without encoding the audio data.

Hereinafter, embodiments for carrying out the disclosure will be described with reference to the drawings.

### First Embodiment

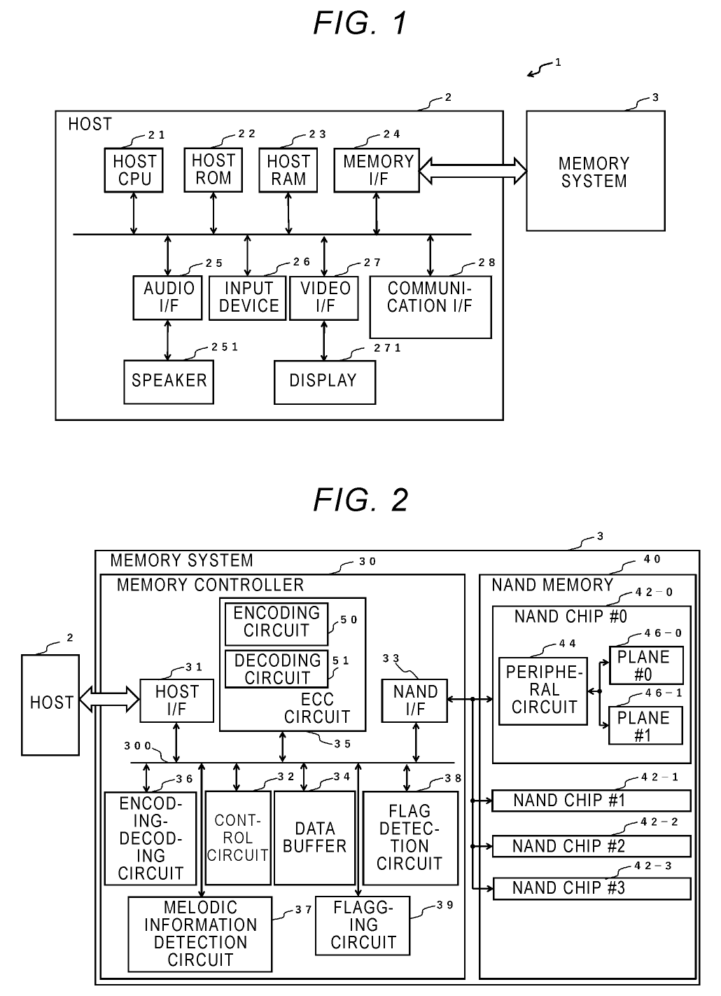

FIG. 1 is a block diagram illustrating a configuration of an information processing system 1 including a memory system 3 according to a first embodiment. The information processing system 1 includes a host 2 and the memory system 3. In one embodiment, the information processing system 1 is an audio system.

The host 2 may be, for example, an information processing device such as a personal computer or an audio device, or a mobile terminal such as a tablet computer or a smartphone. The memory system 3 is connected to the host 2 via a communication line and functions as an external storage device for the host 2.

The host 2 includes, for example, a host central processing unit (CPU) 21, a host read only memory (ROM) 22, a host random access memory (RAM) 23, a memory interface (I/F) 24, an audio I/F 25, a speaker 251, an input device 26, a video I/F 27, a display 271, and a communication I/F 28. The host CPU 21, the host ROM 22, the host RAM 23, the memory I/F 24, the audio I/F 25, the input device 26, the video I/F 27, and the communication I/F 28 are connected to each other via a bus.

The host CPU 21 is a processor and controls the host 2. The host ROM 22 records programs such as a boot program, a data update program, and a specific information acquisition program. The host RAM 23 is used as a work area for the host CPU 21. In other words, the host CPU 21 controls the host 2 by using the host RAM 23 as a work area and executing various programs recorded in the host ROM 22.

The memory I/F 24 is an interface circuit for reading and writing data from and into the memory system 3 under the control of the host CPU 21, and transmits a read request, a write request, and the like to the memory system 3. Here, the write request specifies write data, a logical address (i.e., a start logical address), and a size of the write data. The write request is a command for requesting the memory system 3 to write the write data into a storage region of a NAND memory 40 corresponding to the start logical address and the size thereof.

The read request specifies the logical address (i.e., a start logical address) and the size of the data to be read. The read request is a command for requesting the memory system 3 to read the data from the storage region of the NAND memory 40 corresponding to the start logical address and the size thereof.

Examples of the write data specified in the write request include music data and the like. The music data is also referred to as melodic data or audio data.

The audio I/F 25 is an interface circuit connected to the speaker 251 for audio output. The speaker 251 outputs audio which is obtained by digital-to-analog (D/A) converting predetermined music data via the audio I/F 25. The audio I/F 25 may also be connected to two speakers 251 for the right and left ears of a user.

The input device 26 may be a remote control, a keyboard, a touch panel, or the like, which has a plurality of keys for inputting text, numbers, various instructions, and the like. The input device 26 may be implemented by any one element of the remote control, the keyboard, and the touch panel, or may be implemented by a plurality of elements thereof.

The video I/F 27 is an interface circuit connected to the display 271. Specifically, the video I/F 27 includes, for example, a graphic controller, a buffer memory, a control IC, and the like. The graphic controller controls the entire display 271. The buffer memory such as a video RAM (VRAM) temporarily records image information which can be immediately displayed. The control IC controls the display 271 on the basis of the image data which is output from the graphic controller.

The display 271 displays various pieces of data such as icons, cursors, menus, windows, text, and images. The display 271 may also display text and image information and reproduction time related to the above-mentioned melodic information. For example, the display 271 may employ a liquid crystal display or the like.

The communication I/F 28 is a network interface circuit connected to a network through wireless communication and functions as an interface with the network. The communication I/F 28 is further connected to a communication network such as the Internet through wireless or wired communication and also functions as an interface between the communication network and the host CPU 21. Then, desired music data can be obtained from a server on the Internet.

The host CPU 21 is able to store the music data in the memory system 3 by sending the write request. By sending the read request to the memory system 3, the music data can be read from the memory system 3.

The host CPU 21 executes a predetermined music reproduction program recorded in the host ROM 22 or the like, and controls each element in the host 2. That is, the host 2 is able to reproduce the music data, which is read from the memory system 3, by executing the music reproduction program recorded in the host ROM 22.

FIG. 2 is a block diagram illustrating a configuration of the memory system according to the first embodiment.

The memory system 3 may be a memory card in which a memory controller 30 and the NAND memory 40 are integrated into a single package, or may be an SSD.

The memory controller 30 controls writing of data into the NAND memory 40 in accordance with a write command issued from the host 2. The memory controller 30 controls reading of data from the NAND memory 40 in accordance with a read request issued from the host 2.

The NAND memory 40 is an example of the nonvolatile memory. The nonvolatile memory is not limited to the NAND memory, and may be a NOR flash memory or other types of the nonvolatile memory. The nonvolatile memory may be a two-dimensional memory or a three-dimensional memory.

The NAND memory 40 has a plurality of NAND chips. For example, the NAND memory 40 has four NAND chips: NAND chip #042-0, NAND chip #1 42-1, NAND chip #2 42-2, and NAND chip #342-3. The NAND chips 42-0 to 42-3 are collectively referred to as NAND chips 42 when it is not necessary to distinguish therebetween. Each NAND chip 42 has a peripheral circuit 44 and a plurality of planes. For example, each NAND chip 42 has two planes including a plane #046-0 and a plane #146-1. Each NAND chip 42 may have two or more planes. The planes 46-0 and 46-1 are collectively referred to as planes 46 when it is not necessary to distinguish therebetween.

The memory controller 30 includes a host I/F 31, a control circuit 32, a NAND I/F 33, a data buffer 34, an ECC circuit 35, an encoding-decoding circuit 36, a melodic information detection circuit 37, a flag detection circuit 38, and a flagging circuit 39. The host I/F 31, the control circuit 32, the NAND I/F 33, the data buffer 34, the ECC circuit 35, the encoding-decoding circuit 36, the melodic information detection circuit 37, the flag detection circuit 38, and the flagging circuit 39 are connected via an internal bus 300.

The host I/F 31 performs processing in accordance with the interface standard with the host 2, and outputs commands which are received from the host 2 to the internal bus 300. As the interface for connecting the host 2 and the memory system 3 to each other, SCSI, serial attached SCSI (SAS), ATA, serial ATA (SATA), PCI express (PCIe), Ethernet (registered trademark), Fibre channel, NVM express (NVMe) (registered trademark), and the like may be used. The host I/F 31 transmits the user data which is read from the NAND memory 40, a response sent from the control circuit 32, and the like to the host 2.

The control circuit 32 controls each element of the memory system 3. The control circuit 32 may be implemented by hardware, or may be implemented by a processor such as a CPU executing firmware. In the latter case, for example, when the memory system 3 is supplied with power, the processor reads firmware (i.e., a control program) stored in a ROM (not shown) onto the data buffer 34 or a RAM (not shown) in the control circuit 32 and executes predetermined processing, thereby realizing the processing of the control circuit 32. Here, the processor is also referred to as a core or a processor core.

When receiving the write request from the host 2, the control circuit 32 determines a storage region (or a memory area) on the NAND memory 40 for the user data specified by the write request. In other words, the control circuit 32 manages the write destination of the user data. The association between the logical address of the user data received from the host 2 and the physical address indicating the storage region on the NAND memory 40, in which the user data is stored, is stored as an address conversion table. The control circuit 32 also manages and stores the address conversion table as management information, and also stores information for managing the memory system 3 other than the address conversion table in the management information.

When receiving a read request from the host 2, the control circuit 32 converts the logical address specified by the read request into a physical address using the address conversion table described above, and instructs the NAND I/F 33 to read from the physical address.

The control circuit 32 executes various calculations. For example, the control circuit 32 executes data encoding processing, randomization processing, and the like.

The NAND I/F 33 controls the NAND memory 40. The NAND I/F 33 erases the data stored in the NAND memory 40 in accordance with the control of the control circuit 32, and the like.

The data buffer 34 temporarily stores the user data received from the host 2 by the memory controller 30 until the NAND memory 40 stores the data. The data buffer 34 temporarily stores the user data which is read from the NAND memory 40 before transmitting the data to the host 2. The data buffer 34 includes a general-purpose memory such as a static random access memory (SRAM) or a dynamic random access memory (DRAM). The data buffer 34 may be implemented inside the memory controller 30, or may be implemented outside the memory controller 30 independently of the memory controller 30.

The ECC circuit 35 includes an encoding circuit 50 and a decoding circuit 51. The control circuit 32 corrects data errors using the ECC circuit 35. The control circuit 32 encodes data using the encoding circuit 50 and generates a code word having the data and a redundant part (i.e., parity bits), and instructs the NAND I/F 33 to write the code word into the NAND memory 40. The control circuit 32 acquires the code word, which is the data read from the NAND memory 40, through the NAND I/F 33, by using the decoding circuit 51 and decodes the obtained code word.

The encoding-decoding circuit 36 executes encoding processing and decoding processing. The encoding processing is processing of encoding the data to be written into the NAND memory 40 with an encryption key in accordance with security requirements and concealing the data. The decoding processing is processing of decoding the encoded data, which is read from the NAND memory 40, with the same encryption key as the encryption key used for encoding in accordance with security requirements. If the encoding-decoding circuit 36 fails to decode the encoded data, the encoding-decoding circuit 36 notifies the processor 22 of the failure of decoding. The encoding-decoding circuit 36 may be implemented inside the host I/F 31.

The flag detection circuit 38 checks whether a flag is assigned to music data. The flag detection circuit 38 may be implemented inside the NAND I/F 33.

The flagging circuit 39 assigns a flag to the music data. For example, ... The flagging circuit 39 may be implemented inside the host I/F 31.

In the memory system 3 according to the first embodiment, the memory controller 30 accesses the NAND memory 40 when receiving a read request, a write request, a data erase request, a data deletion request such as a trim command, or the like from the host 2, or when the memory controller 30 executes garbage collection (also referred to as "compaction"), refresh, wear leveling, patrol read, direct memory access, or the like in the background.

The garbage collection is also referred to as compaction. The data erase unit and data read/write unit of the NAND memory 40 are different. Therefore, blocks are fragmented by invalid data as the rewriting of the NAND memory 40 progresses, and the number of available blocks decreases as the number of such fragmented blocks increases. The garbage collection means processing of increasing the number of available blocks. For example, the garbage collection means processing of collecting valid data from a plurality of active blocks that contain valid data and invalid data, rewriting the data into another block, and ensuring a free block.

The active block is a block in which valid data is recorded. The free block is a block in which no valid data is recorded. After being erased, the free block can be reused as an erased block. In the present embodiment, the free block includes both a non-erased block in which no valid data is recorded and an erased block. Valid data is associated with a logical address, and invalid data is not associated with any logical address. When data is written into an erased block, the erased block becomes an active block.

The refresh is processing of rewriting data within a detected block into another block when detecting degradation of data within the block such as an increase in the number of correction bits in error correction processing.

The wear leveling is processing of equalizing the number of rewrites of the blocks in the NAND memory 40 by replacing data, which is stored in a block having a large number of rewrites or erases, with data, which is stored in a block having a small number of rewrites or erases.

The patrol read is, for example, processing of reading data stored in the NAND memory 40 in predetermined units and testing the read data on the basis of the error correction results, in order to detect blocks having an increased number of errors. In this test processing, for example, the number of error bits in the read data is compared with a threshold value, and data of which the number of error bits is greater than the threshold value is subject to the refresh.

The direct memory access is, for example, processing of directly transferring data between the host 2 and the memory system 3 without going through the control circuit 32. For example, in the reading of the data, the direct memory access includes processing of transferring the read data from the NAND memory 40 to the data buffer 34 and processing of transferring the read data from the data buffer 34 to the host 2.

In the memory system 3 according to the first embodiment, a clock gating technique is applied to a clock signal for controlling operations of the circuit. The clock gating technique restricts supply of the system clock signal for each circuit block. The system clock signal is supplied to the necessary circuit block at the necessary timing, and power consumption of the memory system 3 can be minimized.

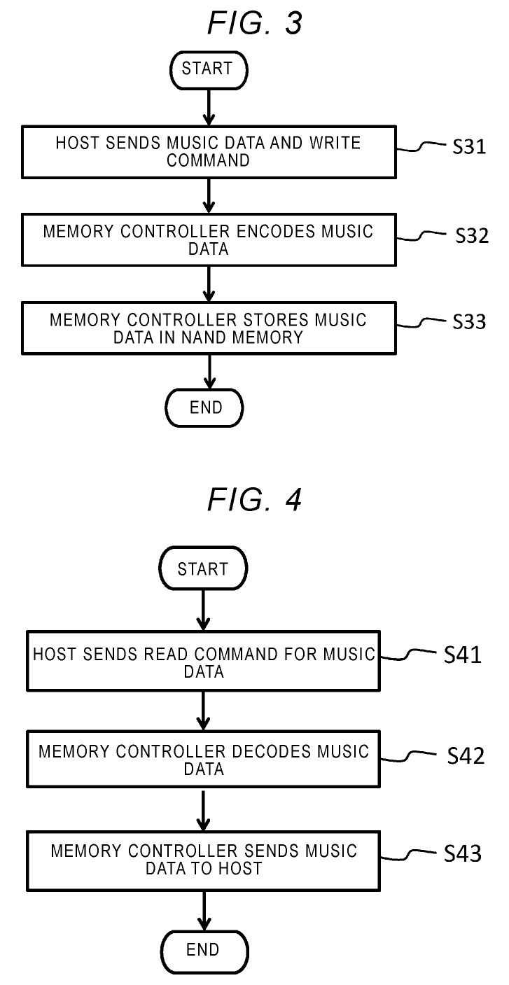

An overview of writing the music data into a memory system according to a comparative example will be described with reference to the flowchart of FIG. 3.

In step S31, a host transmits music data and a write command to the memory system. In step S32, the memory controller encodes the music data. In step S33, the memory controller writes the music data into the NAND memory.

An overview of reading the music data in the memory system according to the comparative example will be described with reference to the flowchart in FIG. 4.

In step S41, the host transmits a command to read the music data. In step S42, the memory controller decodes the encoded music data. The encryption key used in the decoding processing is the same as the encryption key used in the encoding processing in step S32. In step S43, the memory controller transmits the music data to the host, and reading is completed.

In other words, when the memory system according to the comparative example reads music data from the NAND memory, the decoding processing is performed. Generally, the host reproduces the music data at the same timing as reading of the music data. It is known that a steep change in power causes high-frequency noise, which deteriorates a sound quality when the music data is reproduced. That is, when processing is performed that is likely to cause a steep change in power in the memory system, high-frequency noise occurring in the memory system is also likely to increase.

Therefore, the memory system 3 according to the first embodiment operates in either the normal mode or the high quality mode. The host 2 sends a command to the memory system 3 to switch between the normal mode and the high quality mode. When the memory system 3 according to the first embodiment operates in the high quality mode, the music data is stored without encoding.

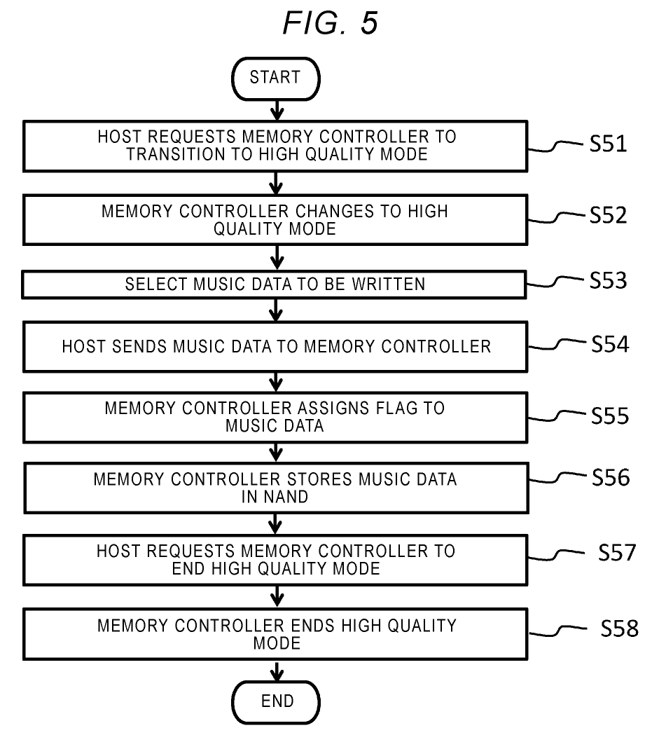

An overview of the memory system 3 according to the first embodiment when writing music data in the high quality mode will be described with reference to the flowchart of FIG. 5. In step S51, when a user requests the high quality mode, the host 2 transmits, to the memory controller 30, a command requesting a transition to the high quality mode. In step S52, the memory controller 30 transitions to the high quality mode.

In step S53, the user selects music data to be written in the high quality mode. In step S54, the host 2 transmits the music data to the memory controller 30. In step S55, the memory system 3 assigns a flag to the music data. Specifically, the flagging circuit 39 assigns a flag to the music data. In step S56, the memory controller 30 stores the music data in the NAND memory 40. In such a case, the music data is not encoded.

When the music data selected by the user is entirely written, the host 2 requests the memory controller 30 to end the high quality mode in step S57. In step S58, the memory controller 30 ends the high quality mode, and the writing of the music data in the high quality mode is completed.

Here, the error correction processing performed by the ECC circuit 35 is different from the encoding processing performed by the encoding-decoding circuit 36. In the high quality mode, the memory system 3 according to the first embodiment does not perform the encoding processing. In the high quality mode, the memory system 3 according to the first embodiment performs encoding using the ECC circuit 35 in a period after step S54 in which the host transmits the music data to the memory controller 30 and before completion of step S56 in which the memory controller 30 stores the music data in the NAND memory 40.

When the first embodiment is in the normal mode, the music data is written into the NAND memory 40 as in the comparative example. In such a case, no flag is assigned to the music data.

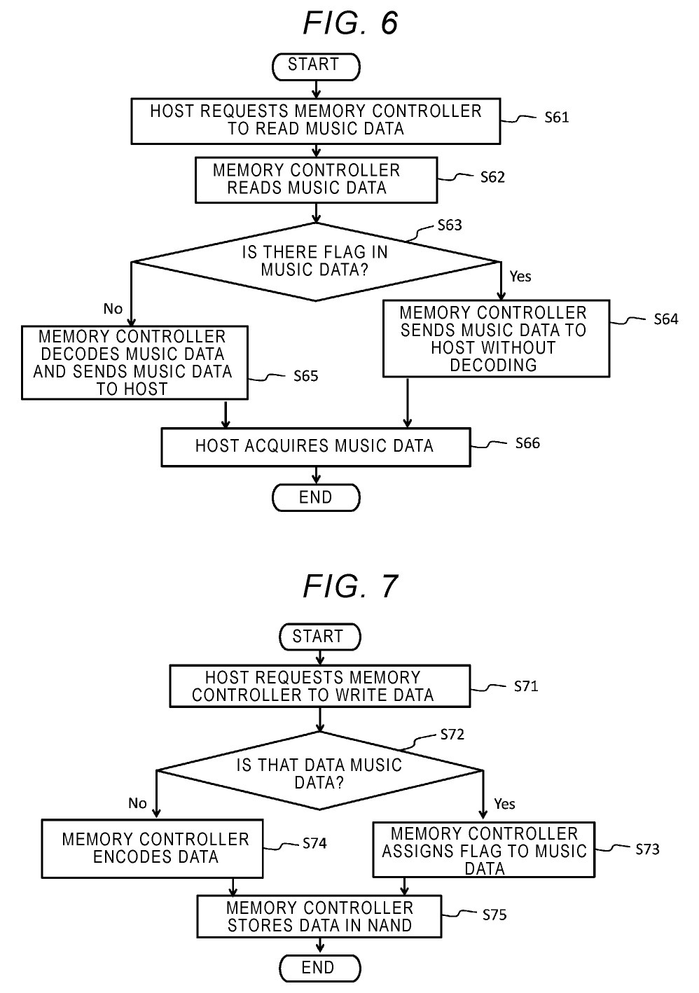

An overview of reading the music data in the memory system 3 according to the first embodiment will be described with reference to the flowchart in FIG. 6. In step S61, the host 2 requests the memory controller 30 to read music data. In step S62, the memory controller 30 reads the music data designated by the host 2. In step S63, the memory controller 30 determines whether a flag is assigned to the read music data. Specifically, the flag detection circuit 38 may check the music data loaded in the data buffer 34. The flag detection circuit 38 may check the music data passing through the NAND I/F 33.

If the flag is present in the music data (Yes in step S63), the memory controller 30 transmits the music data to the host 2 in step S64. In such a case, the encoding-decoding circuit 36 does not perform decoding processing, and the processing proceeds to step S66. If the flag is not present in the music data (No in step S63), the encoding-decoding circuit 36 in the memory controller 30 performs the decoding processing on the music data in step S65. Then, the memory controller 30 transmits the music data to the host 2.

In step S66, the host 2 acquires the music data. Then, for example, the music data is reproduced.

In the first embodiment, the music data written in high quality mode is not encoded and is written into the NAND memory 40 with the flag assigned. Therefore, the music data can be read without the decoding processing. As a result, high frequency noise can be prevented from being likely to occur in the memory system 3.

When the data to be written is music data, the memory controller 30 may write the music data into the NAND memory 40 without the encoding processing. An overview of the case will be described using the flow chart in FIG. 7.

In step S71, the host 2 requests the memory controller 30 to write data. In step S72, the memory controller 30 determines whether the data to be written is music data. Specifically, the melodic information detection circuit 37 in the memory controller 30 determines whether the data to be written is music data. If the data to be written is music data (Yes in step S72), the memory controller 30 assigns a flag to the music data in step S73 and proceeds to step S75. If the data to be written is not music data (No in step S72), the memory controller 30 encodes the data in step S74. Then, in step S75, the memory controller 30 writes the data into the NAND memory 40.

### Second Embodiment

Hereinafter, a memory system 3 according to a second embodiment will be described. The components of the memory system 3 according to the second embodiment having the same function as the memory system 3 according to the first embodiment are represented by the same reference numerals and signs. Detailed descriptions of the similar components between the memory system 3 according to the second embodiment and the memory system 3 according to the first embodiment may not be repeated.

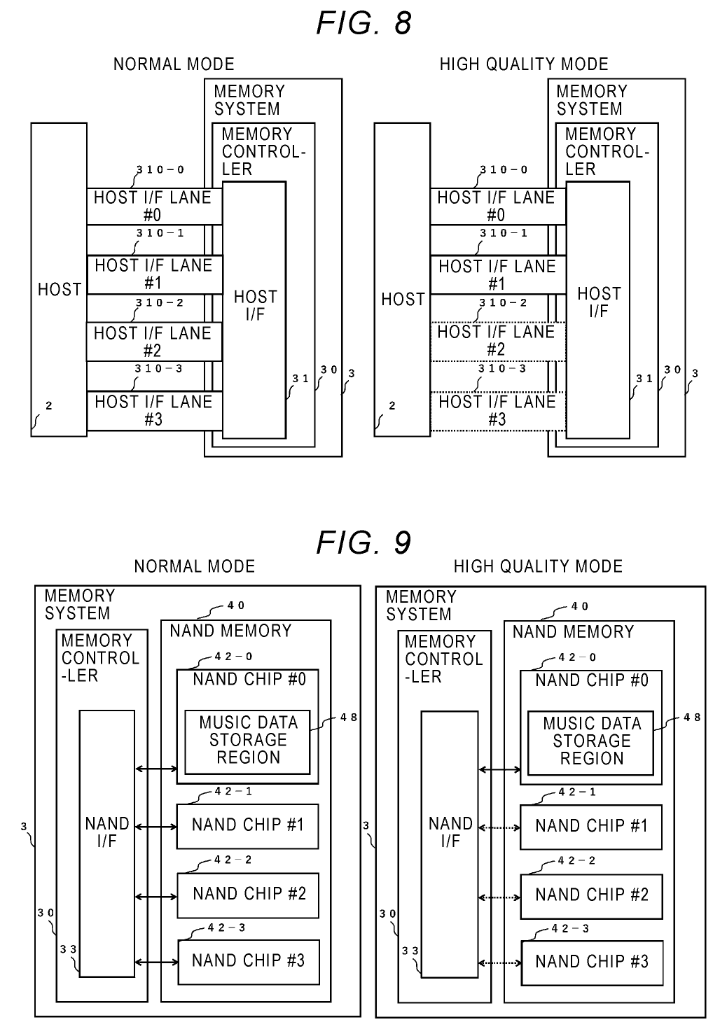

FIG. 8 is a block diagram of the memory system 3 according to the second embodiment, focusing on the host I/F 31. For example, the host I/F 31 includes host I/F lanes 310-0, 310-1,310-2, and 310-3. When it is not necessary to distinguish between the host I/F lanes 310-0 to 310-3, the host I/F lanes 310-0 to 310-3 are collectively referred to as host I/F lanes 310. In the given example, four host I/F lanes 310 are provided. However, the number of host I/F lanes 310 is not limited to four, and the number of host I/F lanes 310 may be any natural number.

In the normal mode of the memory system 3 according to the second embodiment, the memory controller 30 transmits and receives signals to and from the host 2 using the host I/F lanes 310-0 to 310-3.

In the high quality mode of the memory system 3 according to the second embodiment, the number of host I/F lanes 310 to be used can be changed. For example, the memory controller 30 transmits and receives signals to and from the host using two host I/F lanes 310 including the host I/F lane 310-0 and the host I/F lane 310-1. In the given example, the number of used host I/F lanes 310 is two. However, the number of used host I/F lanes 310 is not limited to two. The number of used host I/F lanes 310 is a natural number less than the number of all host I/F lanes 310. In the high quality mode, it is preferable that the memory system 3 according to the second embodiment has performance which is sufficient to transmit the music data to the host.

In the normal mode, in the memory system 3 according to the second embodiment, the host I/F 31 operates at the highest performance. Specifically, the memory controller 30 transmits and receives signals to and from the host 2 using all the host I/F lanes 310. On the other hand, in the high quality mode, the memory system 3 according to the second embodiment transmits and receives signals to and from the host 2 using the number of host I/F lanes 31 sufficient to transmit the music data to the host 2. A speed of the host I/F 31 in the high quality mode is lower than a speed of the host I/F 31 in the normal mode. In the high quality mode, a steep change in power is prevented by lowering the performance of the host I/F. As a result, high frequency noise can be prevented from being likely to occur in the memory system 3.

### Third Embodiment

Hereinafter, a memory system 3 according to a third embodiment will be described. The components of the memory system 3 according to the third embodiment having the same functions of the memory system 3 according to the first embodiment are represented by the same reference numerals and signs. Detailed descriptions of the similar components between the memory system 3 according to the third embodiment and the memory system 3 according to the first embodiment may not be repeated.

FIG. 9 is a block diagram of the memory system 3 according to the third embodiment, focusing on the NAND chip 42. In the memory system 3 according to the third embodiment, a specific NAND chip 42 has a music data storage region 48. Only music data is stored in the music data storage region 48. The plurality of NAND chips 42 each may have the music data storage region 48. In the given example of FIG. 9, the NAND chip 42-0 has the music data storage region 48, but the present disclosure is not limited thereto.

In the normal mode of the memory system 3 according to the third embodiment, the NAND I/F 33 is able to transmit and receive signals to and from all the NAND chips 42.

In the high quality mode of the memory system 3 according to the third embodiment, the functions of the NAND chips 42 not having the music data storage region 48 are restricted. That is, the NAND I/F 33 is unable to transmit and receive signals to and from the NAND chips 42 not having the music data storage region 48. The NAND I/F 33 is able to transmit and receive signals only to and from the NAND chip 42-0 having the music data storage region 48.

In the high quality mode of the memory system 3 according to the third embodiment, for example, a clock of the NAND chip 42 not having the music data storage region 48 is stopped under clock gating control. In such a manner, the high quality mode of the memory system 3 according to the third embodiment is realized by restricting the function of the NAND chip 42 not having the music data storage region 48.

For example, the memory system 3 according to the third embodiment may be configured to have a different power supply circuit for each NAND chip 42. In such a case, the function is restricted by turning off the power supply of the NAND chip 42 not having the music data storage region 48. As a result, the high quality mode of the memory system 3 according to the third embodiment is realized.

In the high quality mode of the memory system 3 according to the third embodiment, only the NAND chip 42 having the music data storage region 48 functions, and the NAND chip 42 not having the music data storage region 48 does not function. In the high quality mode, a steep change in power is prevented by lowering the performance of some of the NAND chips 42. As a result, high frequency noise can be prevented from being likely to occur in the memory system 3.

If the music data storage region 48 is constantly present in the specific NAND chip 42, the number of times of rewriting and erasing increases only in the specific NAND chip 42, and the number of times of rewriting and erasing decreases in the other NAND chips 42. For this reason, the NAND chip 42 having the music data storage region 48 may be configured to be changed at certain intervals.

The memory system 3 according to the third embodiment generates a music data storage region, which is not shown in the drawing and is different from the music data storage region 48, in the NAND chip 42-1 having a small number of times of rewriting and erasing. The music data stored in the music data storage region 48 of the NAND chip 42-0 is stored in the music data storage region not shown in the drawing in the NAND chip 42-1. The music data storage region 48 belonging to the NAND chip 42-0 is erased. By periodically replacing the music data storage regions in such a manner, the number of times of rewriting of the blocks of the NAND memory 40 can be equalized.

### Fourth Embodiment

Hereinafter, a memory system 3 according to a fourth embodiment will be described. The components of the memory system 3 according to the fourth embodiment having the same functions of the memory system 3 according to the first embodiment are denoted by the same reference numerals and signs. Detailed descriptions of the similar components between the memory system 3 according to the fourth embodiment and the memory system 3 according to the first embodiment may not be repeated.

In the memory system 3 according to the fourth embodiment, various kinds of processing operating in the background are not performed in the high quality mode. Specifically, the memory system 3 performs processing of compaction, garbage collection, refresh, wear leveling, patrol read, and direct memory access at a predetermined timing in the normal mode. However, the memory system 3 reduces the frequency of the processing in the high quality mode. By not performing the above-mentioned processing in the high quality mode, a steep change in power in the high quality mode is prevented. As a result, high frequency noise can be prevented from being likely to occur in the memory system 3.

The present disclosure is not limited to the above-described embodiments, and various modifications may be made without departing from the spirit of the present disclosure.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An external memory system for an audio device, comprising:
a nonvolatile memory including a plurality of nonvolatile memory chips; and
a memory controller configured to communicate with the audio device and store, in the nonvolatile memory, audio data transmitted from the audio device, wherein
the memory controller is configured to:
switch between a normal mode and a high quality mode,
upon receipt of audio data in the normal mode, encode the audio data and store the encoded audio data in the nonvolatile memory, and
upon receipt of audio data in the high quality mode, assign a flag to the audio data and store the audio data in the nonvolatile memory without encoding the audio data.

2. The external memory system according to claim 1, wherein
the memory controller is configured to:
in response to an instruction to read audio data stored in the nonvolatile memory, detect whether a flag is assigned to the audio data to be read,
when a flag is not assigned to the audio data to be read, decode and transmit the audio data to the audio device, and
when a flag is assigned to the audio data to be read, transmit the audio data to the audio device without decoding the audio data.

3. The external memory system according to claim 1, wherein the memory controller switches between the normal mode and the high quality mode in response to an instruction issued from the audio device.

4. The external memory system according to claim 1, wherein
the memory chips include a first chip for storing audio data only and a second chip for storing any data, and
the memory controller stores the audio data in the first chip.

5. The external memory system according to claim 4, wherein the memory controller is configured to restrict supply of a system clock to the second chip in the high quality mode.

6. The external memory system according to claim 4, wherein the memory controller is configured to, after passage of a certain period of time, move the audio data stored in the first chip to the second chip, and then, upon receipt of additional audio data, store the additional audio data in the second chip.

7. The external memory system according to claim 1, wherein a speed for transferring audio data in the high quality mode is slower than a speed for transferring audio data in the normal mode.

8. The external memory system according to claim 1, wherein in the high quality mode, the memory controller is configured to perform compaction, garbage collection, refresh, wear leveling, patrol reads, and direct memory access operations less frequently than in the normal mode.

9. The external memory system according to claim 1, wherein
the memory controller includes an interface connectable to the audio device to receive audio data through a plurality of interface lanes, and
in the high quality mode, fewer interface lanes are used to receive audio data than in the normal mode.

10. The external memory system according to claim 1, wherein the memory controller is configured to:
upon receipt of data, determine whether the received data is audio data,
upon determining that the received data is not audio data, encode the received data and store the encoded data in the nonvolatile memory, and
upon determining that the received data is audio data, assign a flag to the received data and store the received data in the nonvolatile memory without encoding the received data.

11. A method performed by an external memory system with a nonvolatile memory for an audio device, the method comprising:
connecting to the audio device;
switching between a normal mode and a high quality mode;
upon receipt of audio data from the audio device in the normal mode, encoding the audio data and storing the encoded audio data in the nonvolatile memory; and
upon receipt of audio data from the audio device in the high quality mode, assigning a flag to the audio data and storing the audio data in the nonvolatile memory without encoding the audio data.

12. The method according to claim 11, further comprising:
in response to an instruction to read audio data stored in the nonvolatile memory, detecting whether a flag is assigned to the audio data;
when a flag is not assigned to the audio data, decoding and transmitting the audio data to the audio device; and
when a flag is assigned to the audio data, transmitting the audio data to the audio device without decoding the audio data.

13. The method according to claim 11, wherein the normal mode and the high quality mode are switched in response to an instruction issued from the audio device.

14. The method according to claim 11, wherein
the nonvolatile memory includes a first chip for storing audio data only and a second chip for storing any data, and
the audio data received from the audio device is stored in the first chip.

15. The method according to claim 14, further comprising:
restricting supply of a system clock to the second chip in the high quality mode.

16. The method according to claim 14, further comprising:
after passage of a certain period of time, moving the audio data stored in the first chip to the second chip, and then, upon receipt of additional audio data, storing the additional audio data in the second chip.

17. The method according to claim 11, wherein a speed for transferring audio data in the high quality mode is slower than a speed for transferring audio data in the normal mode.

18. The method according to claim 11, wherein in the high quality mode, performing compaction, garbage collection, refresh, wear leveling, patrol reads, and direct memory access operations less frequently than in the normal mode.

19. The method according to claim 11, wherein
audio data is transferred from the audio device to the external memory system through a plurality of interface lanes, and
in the high quality mode, fewer interface lanes are used to transfer audio data than in the normal mode.

20. An audio system comprising:
an audio device configured to play audio data; and
an external memory system connectable to the audio device for storing the audio data, the external memory system including:
a nonvolatile memory, and
a memory controller configured to:
switch between a normal mode and a high quality mode,
upon receipt of the audio data from the audio device in the normal mode, encode the audio data and store the encoded audio data in the nonvolatile memory, and
upon receipt of audio data from the audio device in the high quality mode, assign a flag to the audio data and store the audio data in the nonvolatile memory without encoding the audio data.
